(19) United States
(12) Patent Application Publication
(10) Pub. No.: US 2011/0161469 A1
(43) Pub. Date: Jun. 30, 2011

(54) METHOD FOR BUILDING SPONTANEOUS VIRTUAL COMMUNITIES BASED ON COMMON INTERESTS USING INTEREST BANDS

(76) Inventors: Claudio Luis De Amorim, Rio de Janeiro (BR); Renato de Castro Dutra, Rio de Janeiro (BR)

(21) Appl. No.: 12/808,322

(22) PCT Filed: Mar. 13, 2009
(86) PCT No.: PCT/BR2009/000067

§ 371 Date: Jun. 15, 2010

(30) Foreign Application Priority Data
Mar. 13, 2008 (BR) PI0800633-4

(51) Int. Cl. G06F 15/177

(52) U.S. Cl. 709/220

(57) ABSTRACT

The present invention refers to a method for establishing communication between equipments within groups and/or communities, which are formed according to the interest of each user. The equipments are programmable, allowing inserting predicates based on the interests of the user, creating interest bands. The communication equipment syntonizes the interests of an user with the interests of a group. The interest bands are formed with predicates which contain both anonymous and identified information; in this case, the user allows such information to be shared with all or with groups of same interest bands. The method is preferably distributed and communication is spontaneous and volatile.

### FIELD OF THE INVENTION

This invention refers to the use of communication equipments with capacity of information storage, where information is inserted by the user, it is obtained from the environment by using sensors, and from a group of users by message passing, while maintaining anonymous the identification of their users. Such information is of personal interests of the user and the equipments exchange information in such a way that equipments located within a certain region automatically detect the presence of the others, transfer and aggregate information among them, forming spontaneous virtual communities with which the users wish to Interact based on common interests and affinities. Furthermore, such common interests and affinities are grouped into interest bands composed of fields, allowing the users to syntonize in and to join themselves in virtual communities and only receive information that interest to the communities. This use of interest bands solves the problem of amount of information that an user nowadays receives in many ways, specifically by electronic means, enabling the user to focus on interests and reducing and optimizing the reception of information by the user. An interest band is composed of predicates (keywords) inserted in the equipment and grouped into interest bands. Given an equipment with stored interests, once it is detected by another equipment with other stored interests, both will automatically exchange and aggregate the interests of each other, making the aggregate interests available to their users, and as long as other similar equipments are detected, new exchange of interests and aggregation will occur and new aggregate interests will be available to the users. At the same time, the equipments will form a communication network which will allow the users to build a spontaneous virtual service network.

### Technical Sector

This invention is to be included in the field of communication systems, more specifically into the formation of virtual networks and virtual sub-networks.

### The State of the Technique

Distributed Computer Systems usually follow a client-server architecture, in which information is centralized into a controller or server element or the equipments communicate with the controller/server to perform some task for an application. As an example of a centralized information architecture, which can be misunderstood with that described in this invention, are sites of social networks (e.g., Orkut and MySpace), which concentrate all the communication in the server, without supporting that a message sent to an interest band will be automatically filtered and delivered to a group. Another example, which does not use the client-server architecture, yet can be mistakenly compared with the one described in this invention, are peer-to-peer (P2P) systems (e.g., e-Mule, Torrent, among others), which have distributed files, but even those systems need some form of hierarchy for working in practice (in this case, a Super-peer, which controls the peers, by redirecting requests according to the communication traffic). This drawback of P2P systems comes from the limited use they make of the Internet Protocol (IP), which demands a server to manage the beginning of a file transfer transaction, which interconnects the peers that hold the required content. The similarity between such P2P systems and the one described in this invention is limited to their common interest in information sharing, however, the shared information in P2P systems is not filtered by interest when a message-passing transaction starts accordingly with the wish of an user, forming a network with sub-networks based only on interest bands. Another comparison which can be mistakenly made is with sites for searching information in the Internet (e.g., Google, Yahoo), where the current interest of an user can be attended. The approach proposed in this invention is different from searching as performed by such sites due to the fact that interest bands are configured a priori and the information is filtered by selecting the predicates of these interest bands. Also, search sites do not support the formation of interest networks, in which the information is received by syntonizing in interest bands.

The above examples of the state-of-technique when joined in do not describe this invention since they do not use syntony of interest bands when a message-passing transaction starts, forming networks and sub-networks upon the act of a user sending a message.

The analogy between the present invention and syntony of frequencies is a way of better understanding how the former works. In frequency syntony, e.g., on radio, there is a frequency band and each frequency slot (channel) has a modulated content that is tuned by an equipment of syntonization, the content demodulated, and it is presented in some form to the user. To change content the user needs only to press the syntony button to another channel. In the case of this invention, the frequency band is the interest band, that is, the frequencies are the interests, and these are composed of keywords named predicates. Predicates are allocated to any position in the interest band to form the interests of a user. Therefore, there exist several interest bands that can be selected by the user, besides it is possible to syntonize several interests simultaneously, thus, the information will be selected according to the interests of the user and only the required information will be presented to the user.

### DETAILED DESCRIPTION OF THE INVENTION

The method is now described: equipments connected to each other by some means with predicates and stored interest bands. Each of the equipments sends and receives interest bands to/from the others, establishing a communication and forming a spontaneous virtual community/group. What enables an equipment to interact with formed groups is the criterion of syntony between the interests chosen by the users. In case of an user places a query using the equipment, it will send the query through the established communication to the other equipments of the same groups that were selected by the syntony, which will send the answer through the established communication, based on the syntony criterion, using the formed virtual community/group. The system will be distributed if the equipments used this method of interest selection, thus avoiding the use of a central equipment to control the send operations or addresses of the equipments.

### The Objectives Do the Invention

The objectives of the present invention comprise:
1) To form spontaneous virtual groups and virtual communities through the information stored in equipments that communicate in a distributed way with no controller or central element.
2) The information is obtained in several ways: inserted by the user, acquired by the user with other means and obtained from the environment which the user has frequented.
3) All the equipments are capable of receiving, transmitting, requesting, and supporting services, simultaneously.
4) There exist two main entities in the equipments which allow groups and communities to be formed: one is the predicate, i.e. keyword, to be inserted by the user or already inserted in the equipments by others. Second is the interest band, a larger set of information (a group of predicates), which is inserted into the equipment by the user accordingly with his/her interests.
5) The predicates are composed of keywords;
6) The equipments use predicates to generate interest bands that will serve to syntonize in the required information;
7) A predicate will be used to identify or not the equipment and/or the user;
8) Communication is established by an unconnected equipment sending an interest band to other equipments already connected in group or community. The interest band will be received by one or more equipment belonged to the group or community whose syntony criterion matches with. These matching equipments will store locally the incoming interest band and they will retransmit it up to a fixed limit of equipments;
9) The fixed limit of equipments is established by the available technology, not limiting the use of this invention;
10) A predicate is composed of any information inserted into the equipment of an user, limited by storage capacity of the equipment, not limiting the use of this invention;
11) A predicate is looked up by some external request that needs to know some information about the user;
12) A predicate is sent to the group of connected equipments by request of an user or by external request;
13) An external request is defined as any service request made to an equipment by another equipment or other user different from the equipment's user or the equipment itself to which the service is requested;
14) An advantage of this invention in relation to the state-of-the-technique is characterized by using a completely distributed approach, without a centralized element or server;
15) An advantage of this invention in relation to the state-of-the-technique is characterized by using two entities named predicate and interest band which allow to establish communication between equipments;
16) An advantage of this invention in relation to the state-of-the-technique is characterized by the built network to be spontaneous and volatile;
17) To use information of sensors with the profile of the user, combining personal information (inserted by the user or user measurements) with information of the environment which the user has frequented.
18) A distributed system with information exchange between equipments, where the exchange is allowed or not;
19) To allow the information exchange to be used preferably in the modes anonymous or identifiable;

Next, it will be described a preferred application of the invention, noting that such a description in any way restricts the use and the scope of the invention. Three users with equipments, in which predicates and interest bands are stored in main memory, where all the three users want to be connected in order to communicate with each other. Each interest band consists of predicates (keywords) which are locally stored into the associate fields of a message composed of two main tuples that define the system variables: Tuple1 (Interest, predicate, attribute, value) and Tuple2 (Band, Channels). These tuples are related with a length in bits and are used in a general project for a system that uses this method. In this example, each predicate has B bits and each interest band has M bits, while it is possible to send several interest bands to allow the selection of information. The predicate is chosen from three fields of keywords: social, professional, and personal. For the social field, the predicate choices are football, tennis, and clothes; for the professional field, the predicates are meeting, supervisees, and lunch; for the personal field the predicates are genre, age, and hair color. For example, these personal keywords can be represented with 1 bit, 3 bits, and 3 bits, for genre, age, hair color, respectively, where genre is 1 for male and 0 for female, age is indicated by range such as 000 (0-5) for babies, 001 (6-12) for children, 010 (13-19) for teenager, 011 (20-29) for grown-up, 100 (30-40) for adult, 101 (40-59) for middle-aged, and 110 (60-100) for old, and the hair color is 000 for blonde, 001 for brown, 002 for chestnut, etc. The first bit of a predicate is to set an equipment as active, when the user wishes to participate in a virtual community, or inactive when the user does not. Therefore, once the three users switch on and activate their equipments, and they become close enough, each pair of equipments will exchange automatically between themselves the interest band that each one stores. If there is syntony between the corresponding fields of the interest bands of a pair of messages according to a defined criterion, such as 10011000 (active, female, grown-up, blonde), both equipments will store the incoming message. If the predicates do not match with the defined criterion, that is, with the interest bands, the equipments will discard the message and also does not retransmit it. This method can be modified without losing merit by having an insertion of a counter within the messages, due to the fact that when equipments do not exactly match with any criterion, is possible some groups to become isolated from each other. When the insertion of a counter is made, for instance a “Time to Live” (TTL) counter, the criterion will become as: only when the TTL of a message becomes zero, the equipment will discard the message. This is only a variation of the method, which uses some criteria of the state-of-the-technique which only reinforces the capacity of the method. Thus, with this method is possible to build groups or communities by using semantics and interests of the user, activating equipments to establish a network, and generating distinct interconnected groups. The interest bands and predicates can be used in conjunction with different combinations such that the users can interact with the established group, by making questions such as, for example, what is the number of connected users or the price of a product in the nearby shops, among others. Based on the density of a group or on the maximum waiting time for an answer, an user can decide to use a less restrictive criterion, for example, to accept an incomplete matching of interest bands such as genre and hair color but ignoring the age, and thus increasing the probability of building a larger community, and to find a particular information. Once a community is built, it is possible to find an unique identification in the set of equipments, using this network, through a combination of predicates because an interest band contains 128 bits and therefore, any user can use them to select with a specific combination of fields of the interest band, and moreover the nodes of such a network will be uniquely identified and thus they can be used to implement a network similar to a P2P network. The resulting network based on predicates and interest bands, which allows building virtual communities, is volatile in the sense that any equipment can drop out of the network, by becoming inactive, switched off, or any other cause. Even so, both the network and the virtual community that is connected through the network will remain in operation, because there have redundant paths, and if any equipment is incapable of communicating with the others for any reason, this will not represent a problem within the scope of the invention due to the inexistence of guarantee of message delivery.

### Industrial Use

The industry that will be benefit most immediately at the moment of deposit of the patent application is the entertainment industry, in which people acquire the equipments at their convenience and use them to form virtual communities. These virtual communities will allow information exchange through passwords, to assist in public security, and will be used to make agreements on personal or collective issues, and to suggest places for personal or group entertainment, among others. This method can be included into equipments and added to pass cards for school bus, it can be included on a card to be coupled to the cellular, inserted into a personal button that is to be checked before a person can enter a private place, used in a social security card, opinion polls, or any type of information with passersby.

1. Method for building spontaneous virtual communities based on common interests, using communication between equipments, transmitting and receiving information, characterized by:
defining predicates in the equipments;
defining interest bands based on predicates;
using the syntony between interest bands of different equipments as criterion of selection of information received by the equipments and to filter said information.

2. Method according to claim 1, characterized by the information defined as confidential by the user.

3. Method according to claim 1, characterized by the information defined as public domain by the user.

4. Method according to claim 1, characterized by the equipment to communicate with other external elements to the group/community.

5. Method according to claim 1, characterized by the equipment to be programmable by the user.

6. Method according to claim 1, characterized by the equipment to be remotely programmable.

7. Method according to claim 1, characterized by the region covered by the equipment to be one of an outdoor environment and an indoor environment.

8. Method according to claim 1, characterized by the use of interest bands as one of full, partial, and any manipulation of said interest bands.

9. Method according to claim 1, characterized by the communication network to be fully distributed.

10. Method according to claim 1, characterized by the predicate to be based on a combination of spatial parameters, temporal parameters, and information.

11. Method according to claim 1, characterized by the predicate to be based on a combination of spatial parameters, temporal parameters, and information.

12. Method according to claim 1, characterized by the use of password by the user.

13. Method according to claim 11, characterized by the access to the interest band.

14. Method according to claim 1, characterized by the use of identification for the equipments.

15. Method according to claim 1, characterized by the use of anonymity for the equipments.

16. Method according to claim 3, characterized by allowing the user to participate in polls.

17. Method according to claim 1, characterized by a message to be an invitation for voting and the reply to be a vote.

18. Method according to claim 1, characterized by a message to be an alarm for a parameter acquired by a sensor.

19. Method according to claim 1, characterized by a plurality of one of groups and communities of persons through the use of interest bands.

20. Method according to claim 18, characterized by the user to send a question to the group and to obtain an answer.

21. Method according to claim 18, characterized by the user to be rejected by the group.

22. Method according to claim 18, characterized by the user to be accepted by the group.

23. Method according to claim 18, characterized by the user to be ignored by the group.

24. Method according to claim 1, characterized by the equipment to be externally configured.

25. Method according to claim 1, characterized by the equipment to have a device that allows visualization and a device that allows input of data for configuration.

26. Method according to claim 1, characterized by intersection between information in the aggregation, allowing a virtual community to be formed.

27. Method according to claim 1, characterized by the information to be one of aggregated and not aggregated, and not to be limited by the use of aggregation.

28. Method according to claim 1, characterized by message passing between equipments.

29. Method according to claim 27, characterized by the use of an identified network for message passing.

30. Method according to claim 27, characterized by participation of 2 or more users.

31. Method according to claim 27, characterized by participation of 2 or more equipments.

32. Method according to claim 1, characterized by the criterion of syntony to be a total identification of each predicate bit by bit presented in the interest band.

33. Method according to claim 1, characterized by the criterion of syntony to be a partial identification of predicates presented in the interest band.

34. Method according to claim 1, characterized by the criterion of syntony to contain a counter in the message.

35. Method according to claim 1, characterized by the counter to be defined as the lifetime of the message.
